(19) United States
(12) Patent Application Publication
(10) Pub. No.: US 2013/0149980 A1
(43) Pub. Date: Jun. 13, 2013

(54) ELECTRONIC DEVICE AND METHOD FOR SWITCHING RADIO RECEIVER

(71) Applicants: YONG-LIANG LU, Shenzhen City (CN); YING-HE ZHAO, Shenzhen City (CN); XUE-SHUN LIU, Shenzhen City (CN); HUAN-HUAN ZHANG, Shenzhen City (CN); BI-QING LUO, Shenzhen City (CN); XIN LU, Shenzhen City (CN); FEI WANG, Shenzhen City (CN); BIAO-GENG ZHONG, Shenzhen City (CN)

(72) Inventors: YONG-LIANG LU, Shenzhen City (CN); YING-HE ZHAO, Shenzhen City (CN); XUE-SHUN LIU, Shenzhen City (CN); HUAN-HUAN ZHANG, Shenzhen City (CN); BI-QING LUO, Shenzhen City (CN); XIN LU, Shenzhen City (CN); FEI WANG, Shenzhen City (CN); BIAO-GENG ZHONG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/586,900

(22) Filed: Aug. 16, 2012

(30) Foreign Application Priority Data
Dec. 13, 2011 (CN) 201110415339.4

(51) Int. Cl. H04B 1/16; H04B 17/00

(52) U.S. Cl. 455/134

(57) ABSTRACT

A method for switching radio receivers includes: directing a FM radio receiver or an Internet radio receiver of an electronic device to receive radio signals; monitoring the intensity of radio signals received by the FM radio receiver and the network data stream received by the Internet radio receiver periodically; determining whether a switch condition for switching radio receivers between the FM radio receiver and the Internet radio receiver is satisfied according to the radio receiver currently employed, the intensity of radio signals received by the FM radio receiver, and the network data stream received by the Internet radio receiver; and switching between the FM radio receiver and the Internet radio receiver if the switch condition is satisfied. A related electronic device is also provided.

### BACKGROUND

1. Technical Field

The present disclosure relates to electronic devices with different radio receivers and, particularly, to an electronic device capable of automatically switching radio receivers and a method for switching radio receivers.

2. Description of Related Art

Some types of electronic devices, for example, smart phones, can receive radio signals through built-in frequency modulation (FM) radio receivers and Internet radio receivers. Under some conditions, for example, when the network signal is weak, it may be better for the electronic device to employ the FM radio receiver to receive radio signals. In other conditions, for example, when the network signal is strong, it may be better for the electronic device to employ the Internet radio receiver to receive radio signals. However, the electronic device cannot automatically select between the FM radio receiver and the Internet radio receiver to better receive radio signals as condition changes.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device with radio receiver switch function, in accordance with an exemplary embodiment.

FIG. 2 is a schematic view of a selection interface provided by the electronic device of FIG. 1, in accordance with an exemplary embodiment.

FIG. 3 is a flowchart of a method for switching radio receivers, in accordance with an exemplary embodiment.

### DETAILED DESCRIPTION

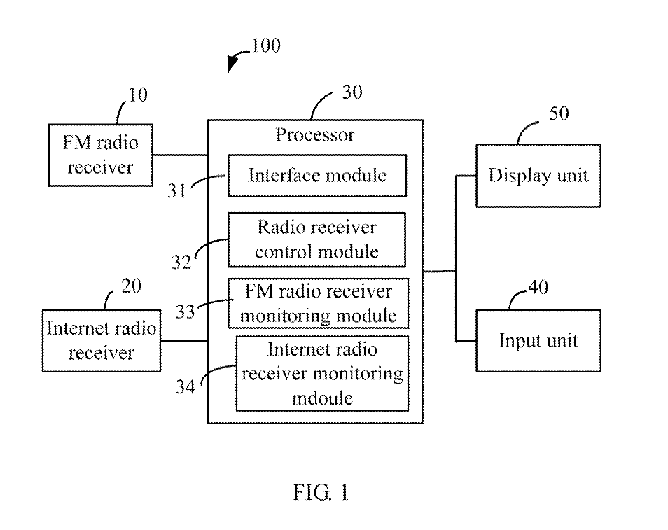

Referring to FIG. 1, an embodiment of an electronic device 100 is shown. The device 100 includes a FM radio receiver 10 and an Internet radio receiver 20. The device 100 further includes a processor 30, an input unit 40, and a display unit 50. The processor 30 includes an interface module 31, a radio receiver control module 32, a FM radio receiver monitoring module 33, and an Internet radio receiver monitoring module 34.

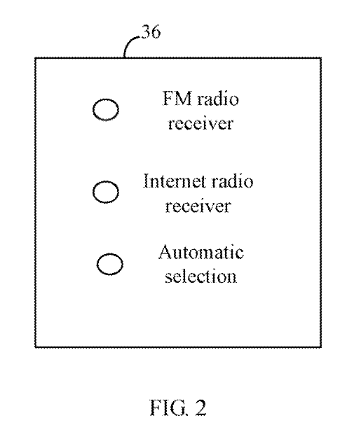

The interface module 31 displays a selection interface 36 (see FIG. 2) on the display unit 50 for users to select a radio receiver for receiving radio signals in response to the input of the user on the input unit 40. In this embodiment, the selection interface 36 includes three options: FM radio receiver, Internet radio receiver, and automatic selection.

The radio receiver control module 32 directs the FM radio receiver 10 to receive radio signals if the option of FM radio receiver is selected, directs the Internet radio receiver 20 to receive radio signals if the option of Internet radio receiver is selected, and directs the FM radio receiver 10 or the Internet radio receiver 20 to receive radio signals according to a preset rule if the option of automatic selection is selected. In this embodiment, the preset rule is that the Internet radio receiver 20 is employed. In an alternative embodiment, the preset rule is that the FM radio receiver 10 is employed.

The FM radio receiver monitoring module 33 periodically monitors the intensity of radio signals received by the FM radio receiver 10 if the option of automatic selection is selected. If the FM radio receiver monitoring module 33 detects that the FM radio receiver 10 is in an off or pause state, the FM radio receiver monitoring module 33 first turns on the FM radio receiver 10 for a preset time period, and then monitors the intensity of radio signals received by the FM radio receiver 10.

The Internet radio receiver monitoring module 34 periodically monitors the network data stream received by the Internet radio receiver 20 if the option of automatic selection is selected. If the Internet radio receiver monitoring module 34 detects that the Internet radio receiver 20 is in an off or pause state, the Internet radio receiver monitoring module 33 first turns on the Internet radio receiver 20 for a preset time period, and then monitors the network data stream received by the Internet radio receiver 20.

The radio receiver control module 32 further determines whether the switch condition for switching between the FM radio receiver 10 and the Internet radio receiver 20 is satisfied according to the radio receiver currently employed, the intensity of radio signals received by the FM radio receiver 10, and the network data stream received by the Internet radio receiver 20. If the switch condition is satisfied, the radio receiver control module 32 switches radio receivers. The detailed switch method is described as follows:

In this embodiment, if the FM radio receiver 10 is currently employed to receive radio signals, the radio receiver control module 32 determines that the switch condition is satisfied if the intensity of radio signals received by the FM radio receiver 10 is less than a preset threshold and the network data stream received by the Internet radio receiver 20 is equal to or greater than a predetermined threshold. If the switch condition is satisfied, the radio receiver control module 32 pauses or turns off the FM radio receiver 10, and directs the Internet radio receiver 20 to receive radio signals. If the Internet radio receiver 20 is currently employed to receive radio signals, the radio receiver control module 32 determines that the switch condition is satisfied if the intensity of radio signals received by the FM radio receiver 10 is equal to or greater than the preset threshold, or the intensity of radio signals received by the FM radio receiver 10 is less than the preset threshold and the network data stream received by the Internet radio receiver 20 is less than the predetermined threshold. If the switch condition is satisfied, the radio receiver control module 32 pauses or turns off the Internet radio receiver 20, and directs the FM radio receiver 10 to receive radio signals.

In an alternative embodiment, if the FM radio receiver 10 is currently employed to receive radio signals, the radio receiver control module 32 determines that the switch condition is satisfied if the network data stream received by the Internet radio receiver 20 is equal to or greater than the predetermined threshold, or the network data stream received by the Internet radio receiver 20 is less than the predetermined threshold and the intensity of radio signals received by the FM radio receiver 10 is less than a preset threshold. If the switch condition is satisfied, the radio receiver control module 32 pauses or turns off the FM radio receiver 10, and directs the Internet radio receiver 20 to receive radio signals. If the Internet radio receiver 20 is currently employed to receive radio signals, the radio receiver control module 32 determines that the switch condition is satisfied if the network data stream received by the Internet radio receiver 20 is less than the predetermined threshold and the intensity of radio signals received by the FM radio receiver 10 is equal to or greater than the preset threshold. If the switch condition is satisfied, the radio receiver control module 32 pauses or turns off the Internet radio receiver 20, and directs the FM radio receiver 10 to receive radio signals.

The radio receiver control module 32 further obtains the broadcast channel currently tuned to if the switch condition is satisfied, and directs the radio receiver which is determined to receive radio signals to receive radio signals of the obtained broadcast channel.

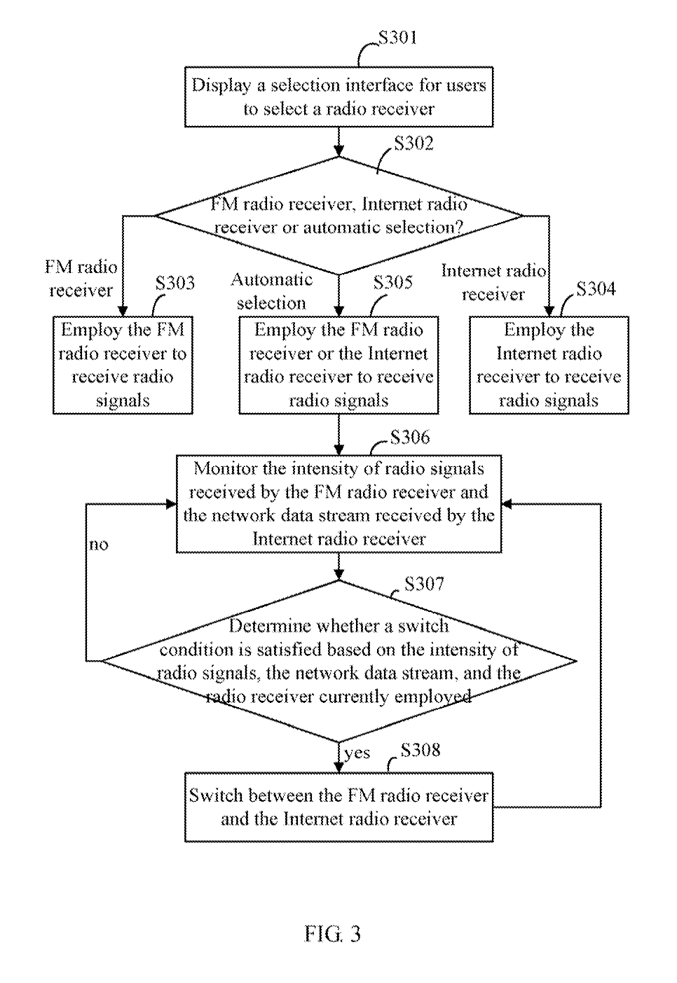

FIG. 3 is a flowchart of a method for switching radio receivers, in accordance with an exemplary embodiment.

In step S301, the interface module 31 displays the selection interface 36 on the display unit 50 for users to select a radio receiver for receiving radio signals in response to user's input on the input unit 40. In this embodiment, the selection interface 36 includes three options: FM radio receiver, Internet radio receiver, and automatic selection.

In step S302, the radio receiver control module 32 determines which of the options on the selection interface 36 is selected.

In step S303, the radio receiver control module 32 directs the FM radio receiver 10 to receive radio signals if the option of FM radio receiver is selected.

In step S304, the radio receiver control module 32 directs the Internet radio receiver 20 to receive radio signals if the option of Internet radio receiver is selected.

In step S305, the radio receiver control module 32 directs the FM radio receiver 10 or the Internet radio receiver 20 to receive radio signals according to a preset rule if the option of automatic selection is selected. In this embodiment, the preset rule is that the Internet radio receiver 20 is employed. In an alternative embodiment, the preset rule is that the FM radio receiver 10 is employed.

In step S306, the FM radio receiver monitoring module 33 periodically monitors the intensity of radio signals received by the FM radio receiver 10, and the Internet radio receiver monitoring module 34 periodically monitors the network data stream received by the Internet radio receiver 20

In step S307, the radio receiver control module 32 determines whether the switch condition for switching between the FM radio receiver 10 and the Internet radio receiver 20 is satisfied according to the radio receiver currently employed, the intensity of radio signals received by the FM radio receiver 10, and the network data stream received by the Internet radio receiver 20. If the switch condition is satisfied, the procedure goes to step S308, otherwise the procedure returns to step S306.

In this embodiment, if the FM radio receiver 10 is currently employed to receive radio signals, the radio receiver control module 32 determines that the switch condition is satisfied if the intensity of radio signals received by the FM radio receiver 10 is less than a preset threshold and the network data stream received by the Internet radio receiver 20 is equal to or greater than a predetermined threshold. If the switch condition is satisfied, the radio receiver control module 32 pauses or turns off the FM radio receiver 10, and directs the Internet radio receiver 20 to receive radio signals. If the Internet radio receiver 20 is currently employed to receive radio signals, the radio receiver control module 32 determines that the switch condition is satisfied if the intensity of radio signals received by the FM radio receiver 10 is equal to or greater than the preset threshold, or the intensity of radio signals received by the FM radio receiver 10 is less than the preset threshold and the network data stream received by the Internet radio receiver 20 is less than the predetermined threshold. If the switch condition is satisfied, the radio receiver control module 32 pauses or turns off the Internet radio receiver 20, and directs the FM radio receiver 10 to receive radio signals.

In an alternative embodiment, if the FM radio receiver 10 is currently employed to receive radio signals, the radio receiver control module 32 determines that the switch condition is satisfied if the network data stream received by the Internet radio receiver 20 is equal to or greater than the predetermined threshold, or the network data stream received by the Internet radio receiver 20 is less than the predetermined threshold and the intensity of radio signals received by the FM radio receiver 10 is less than a preset threshold. If the switch condition is satisfied, the radio receiver control module 32 pauses or turns off the FM radio receiver 10, and directs the Internet radio receiver 20 to receive radio signals. If the Internet radio receiver 20 is currently employed to receive radio signals, the radio receiver control module 32 determines that the switch condition is satisfied if the network data stream received by the Internet radio receiver 20 is less than the predetermined threshold and the intensity of radio signals received by the FM radio receiver 10 is equal to or greater than the preset threshold. If the switch condition is satisfied, the radio receiver control module 32 pauses or turns off the Internet radio receiver 20, and directs the FM radio receiver 10 to receive broadcast signal.

In step S308, if the FM radio receiver 10 is currently employed, the radio receiver control module 32 pauses or turns off the FM radio receiver 10, and directs the Internet radio receiver 20 to receive radio signals, or if the Internet radio receiver 20 is currently employed, the radio receiver control module 32 pauses or turns off the Internet radio receiver 20, and directs the FM radio receiver 10 to receive radio signals. When step S308 is finished, the procedure returns to step S306.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device with radio receiver switch function, comprising:
a frequency modulation (FM) radio receiver;
an Internet radio receiver; and
a processor comprising:
a FM radio receiver monitoring module to monitor the intensity of radio signals received by the FM radio receiver;
an Internet radio receiver monitoring module to monitor network data stream received by the Internet radio receiver; and
a radio receiver control module to determine whether a switch condition for switching between the FM radio receiver and the Internet radio receiver is satisfied according to the radio receiver currently employed, the intensity of radio signals received by the FM radio receiver, and the network data stream received by the Internet radio receiver, and further switch between the FM radio receiver and the Internet radio receiver if the switch condition is satisfied.

2. The electronic device as described in claim 1, wherein the radio receiver control module is to switch to the FM radio receiver to receive radio signals if the Internet radio receiver is currently employed, and the intensity of radio signals received by the FM radio receiver is greater than or equal to a preset threshold.

3. The electronic device as described in claim 1, wherein the radio receiver control module is to switch to the Internet radio receiver to receive radio signals if the FM radio receiver is currently employed, the intensity of radio signals received by the FM radio receiver is less than the preset threshold, and the network data stream received by the Internet radio receiver is greater than or equal to a predetermined threshold.

4. The electronic device as described in claim 1, wherein the radio receiver control module is to switch to the FM radio receiver to receive broadcast signal if the Internet radio receiver is currently employed, the intensity of radio signals received by the FM radio receiver is less than the preset threshold, and the network data stream received by the Internet radio receiver is less than the predetermined threshold.

5. The electronic device as described in claim 1, wherein the radio receiver control module is to switch to the Internet radio receiver to receive radio signals if the FM radio receiver is currently employed, and the network data stream is equal to or greater than the predetermined threshold.

6. The electronic device as described in claim 1, wherein the radio receiver control module is to switch to the FM radio receiver to receive radio signals if the Internet radio receiver is currently employed, the network data stream received by the Internet radio receiver is less than the predetermined threshold, and the intensity of radio signals received by the FM radio receiver is equal to or greater than the preset threshold.

7. The electronic device as described in claim 1, wherein the radio receiver control module is to switch to the Internet radio receiver to receive radio signals if the FM radio receiver is currently employed, the network data stream received by the Internet radio receiver is less than the predetermined threshold, and the intensity of radio signals received by the FM radio receiver is less than the preset threshold.

8. The electronic device as described in claim 1, wherein the radio receiver control module is to obtain the broadcast channel currently tuned to if the switch condition is satisfied, and directs the radio receiver which is determined to receive radio signals to receive radio signals of the obtained broadcast channel.

9. A method for switching radio receivers applied in an electronic device, the electronic device comprising a FM radio receiver and an Internet radio receiver, the method comprising:
directing the FM radio receiver or the Internet radio receiver to receive radio signals;
monitoring the intensity of radio signals received by the FM radio receiver and the network data stream received by the Internet radio receiver periodically;
determining whether a switch condition for switching between the FM radio receiver and the Internet radio receiver is satisfied according to the radio receiver currently employed, the intensity of radio signals received by the FM radio receiver, and the network data stream received by the Internet radio receiver; and
switching between the FM radio receiver and the Internet radio receiver if the switch condition is satisfied.

10. The method as described in claim 9, wherein the electronic device switches to the FM radio receiver to receive radio signals if the Internet radio receiver is currently employed, and the intensity of radio signals received by the FM radio receiver is greater than or equal to a preset threshold.

11. The method as described in claim 9, wherein the electronic device switches to the Internet radio receiver to switch radio signals if the FM radio receiver is currently employed, the intensity of radio signals received by the FM radio receiver is less than the preset threshold, and the network data stream received by the Internet radio receiver is greater than or equal to a predetermined threshold.

12. The method as described in claim 9, wherein the electronic device switches to the FM radio receiver to receive broadcast signal if the Internet radio receiver is currently employed, the intensity of radio signals received by the FM radio receiver is less than the preset threshold, and the network data stream received by the Internet radio receiver is less than the predetermined threshold.

13. The method as described in claim 9, wherein the electronic device switches to the Internet radio receiver to receive radio signals if the FM radio receiver is currently employed, and the network data stream is equal to or greater than the predetermined threshold.

14. The method as described in claim 9, wherein the electronic device switches to the FM radio receiver to receive radio signals if the Internet radio receiver is currently employed, the network data stream received by the Internet radio receiver is less than the predetermined threshold, and the intensity of radio signals received by the FM radio receiver is equal to or greater than the preset threshold.

15. The method as described in claim 9, wherein the electronic device switches to the Internet radio receiver to receive radio signals if the FM radio receiver is currently employed, the network data stream received by the Internet radio receiver is less than the predetermined threshold, and the intensity of radio signals received by the FM radio receiver is less than the preset threshold.

16. The method as described in claim 9, further comprising:
obtaining the broadcast channel currently tuned to if the switch condition is satisfied; and
directing the radio receiver which is determined to receive radio signals to receive radio signals of the obtained broadcast channel.
